(19) United States
(12) Patent Application Publication
(10) Pub. No.: US 2015/0249792 A1
(43) Pub. Date: Sep. 3, 2015

(54) IMAGE PROCESSING DEVICE, IMAGING DEVICE, AND PROGRAM

(71) Applicant: NIKON CORPORATION, Tokyo (JP)

(72) Inventor: Nobuhiro Fujinawa, Yokohama-shi (JP)

(73) Assignee: NIKON CORPORATION, Tokyo (JP)

(21) Appl. No.: 14/421,709

(22) PCT Filed: Aug. 14, 2013
(86) PCT No.: PCT/JP2013/071928

§ 371 Date: May 13, 2015

(30) Foreign Application Priority Data
Aug. 17, 2012 (JP) 2012-180746

(51) Int. Cl. H04N 5/262; G06K 9/62; H04N 5/232

(52) U.S. Cl. CPC H04N 5/2621; H04N 5/23293; G06K 9/6201

(57) ABSTRACT

An image processing device comprising an image input unit (102) for inputting an image, a comment creation unit (110) for carrying out an image analysis of the image and creates a comment, an image editing unit (112) for editing the image on the basis of the results of the analysis, and an image output unit (114) for outputting an output image including the comment and the edited image.

### BACKGROUND OF THE INVENTION

1. Field of the Invention

The present invention relates to an image processing device, an imaging device and a program.

2. Description of the Related Art

Conventionally, a technique for imparting character information to captured images has been developed. For example, Patent document 1 (Japanese Patent Publication No. 2010-206239) discloses a technique for imparting comments related to captured images to the captured images.

### PRIOR ART DOCUMENTS

Patent document 1: Japanese Patent Publication No. 2010-206239

### SUMMARY OF THE INVENTION

The purpose of the present invention is to provide an image processing device, an imaging device and a program which can improve a matching when an image and a comment based on an captured image are displayed at the same time.

In order to achieve the above purpose, an image processing device according to the present invention comprises,

an image input unit (102) which inputs an image,

a comment creation unit which carries cut an image analysis of the image and creates a comment,

an image editing unit (112) which edits the image on the basis of the results of the analysis, and

an image output unit (114) which outputs an output image including the comment and the edited image.

To facilitate understanding, the present invention has been described in association with reference signs of the drawings showing the embodiments, but the present invention is not limited only to them. The configuration of the embodiments described below may be appropriately improved or partly replaced with other configurations. Furthermore, configuration requirements without particular limitations on their arrangement are not limited to the arrangement disclosed in the embodiments and can be disposed at a position where its function can be achieved.

### BRIEF DESCRIPTION OF THE DRAWINGS

FIG. 1 is a schematic block diagram of a camera according to an embodiment of the present invention.

FIG. 2 is a schematic block diagram of an image processing unit shown in FIG. 1.

FIG. 3 is a flowchart showing an example of processing by the image processing unit shown in FIG. 1 and FIG. 2.

FIG. 4 shows an example of image processing by the image processing unit shown in FIG. 1 and FIG. 2.

FIG. 5 shows another example of imago processing by the image processing unit shown in FIG. 1 and FIG. 2.

FIG. 6 shows another example of image processing by the image processing unit shown in FIG. 1 and FIG. 2.

FIG. 7 shows another example of image processing by the image processing unit shown in FIG. 1 and FIG. 2.

FIG. 8 shows another example of image processing by the image processing unit shown in FIG. 1 and FIG. 2.

FIG. 9 snows another example of image processing by the image processing unit shown in FIG. 1 and FIG. 2.

FIG. 10 shows another example of image processing by the image processing unit shown in FIG. 1 and FIG. 2.

FIG. 11 shows another example of image processing by the image processing unit shown in FIG. 1 and FIG. 2.

### DESCRIPTION OF THE EMBODIMENTS

### First Embodiment

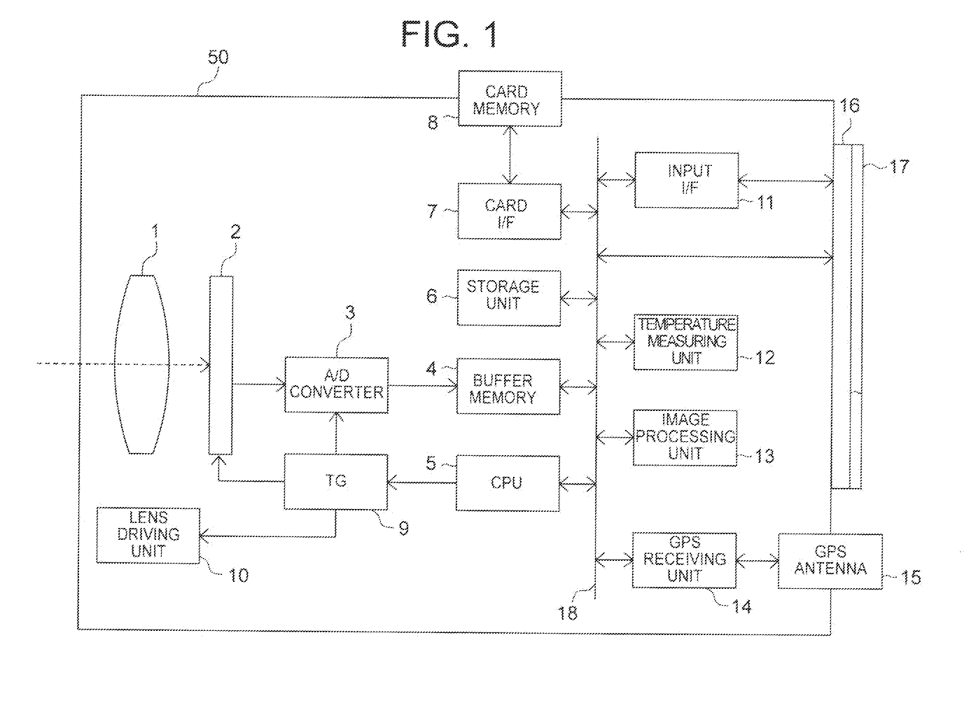

A camera 50 shown in FIG. 1 is a so-called compact digital camera. In the following embodiments, a compact digital camera is explained as an example, but the present invent ion is not limited thereto. For example, it may be a single-lens reflex camera where a lens barrel and a camera body are constructed separately. Further, the present invention can be also applied to mobile devices such as mobile phones, PC and photo frames, not limited to compact digital cameras and digital single-lens reflex cameras.

As shown in FIG. 1, the camera 50 includes an imaging lens 1, an imaging element 2, an A/D converter 3, a buffer memory 4, a CPU 5, a storage unit 6, a card interlace (card I/F) 7, a timing generator (TG) 9, a lens driving unit 10, an input interface (input I/F) 11, a temperature measuring unit 12, an image processing unit 13, a GPS receiving unit 14, a GPS antenna 15, a display unit 16 and a touch panel button 17.

The TG 9 and the lens driving unit 10 are connected to the CPU 5, the imaging element 2 and the A/D converter 3 are connected to the TG 9, and the imaging lens 1 is connected to the lens driving unit 10, respectively. The buffer memory 4, the CPU 5, the storage unit 6, the card I/F 7, the input I/F 11, the temperature measuring unit 12, the image processing unit 13, the GPS receiving unit 14 and the display unit 16 are connected through a bus 18 so as to transmit information.

The imaging lens 1 is composed of a plurality of optical lenses and driven by the lens driving unit 10 based on instructions from the CPU 5 to form an image of a light flux from an object on a light receiving surface of the imaging element 2.

The imaging element 2 operates based on timing pulses emitted by the TG 9 according to a command from the CPU 5 and obtains an image of an object formed by the imaging lens 1 provided in front of the imaging element 2. Semiconductor image sensors such as a CCD or a CMOS can be appropriately selected and used as the imaging element 2.

An image signal output from the imaging element 2 is converted into a digital signal in the A/D converter 3. The A/D converter 3 operates based on timing pulses emitted by the TG 9 according to a command from the CPU 5 along with the imaging element 2. The image signal is stored in the buffer memory 4 after being temporarily stored in a frame memory (not shown in Fig.). Note that an optional non-volatile memory of semiconductor memories can be appropriately selected and used as the buffer memory 4.

When a power button (not shown in Fig.) is pushed by the user to turn on the power of the camera 50, the CPU 5 reads a control program of the camera 50 stored in the storage unit 6 and initializes the camera 50. Thereafter, when receiving the instruction from the user via the input I/F 11, the CPU 5 controls the imaging element 2 for capturing an image of an object, the image processing unit 13 for processing the captured image, the storage unit 6 or a card memory 8 for recording the processed image, and the display unit 16 for displaying the processed image on the basis of a control program.

The storage unit 6 stores an image captured by the camera 50, various programs such as control programs used by the CPU 5 for controlling the camera 50 and comment lists on which comments to be imparted to the captured image are based. Storage devices such as a general hard disk device, a magneto-optical disk device, a flash RAM can be appropriately selected and used as the storage unit 6.

The card memory 8 is detachable mounted on the card I/F 7. The Images stored in the buffer memory 4 are processed by the image processing unit 13 based on instructions from the CPU 5 and stored in the card memory 8 as an image file of Exif format or the like which has header information of imaging information including a focal length, a shutter speed, an aperture value, an ISO value or the like and photographing position or altitude, etc. determined by GPS receiving unit 14 at the time of capturing an image.

Before photographing of an object by the imaging element 2 is performed, the lens driving unit 10 drives the imaging lens 1 to form an image of a light flux from the object on a light receiving surface of the imaging element 2 on the basis of a shutter speed, an aperture value and an ISO value, etc. calculated by the CPU 5, and a focus state obtained by measuring a brightness of the object.

The input I/F 11 outputs an operation signal to the CPU 5 in accordance with the contents of the operation by the user. A power button (not shown in Fig.) and operating members such as a mode setting button for photographing mode, etc. and a release button are connected to the input I/F 11. Further, the touch panel button 17 provided on the front surface of the display unit 16 is connected to the input I/P 11.

The temperature measuring unit 12 measures the temperature around the camera 50 in photographing. A general temperature sensor can be appropriately selected and used as the temperature measuring unit 12.

The GPS antenna 15 is connected to the GPS receiving unit 14 and receives signals from GPS satellites. The GPS receiving unit 14 obtains information such as latitude, longitude, altitude, time and date based on the received signals.

The display unit 16 displays through-images, photographed images, and mode setting screens or the like. A liquid crystal monitor or the like can be appropriately selected and used as the display unit 16. Further, the touch panel button 17 connected to the input I/F 11 is provided on the front surface of the display unit 16.

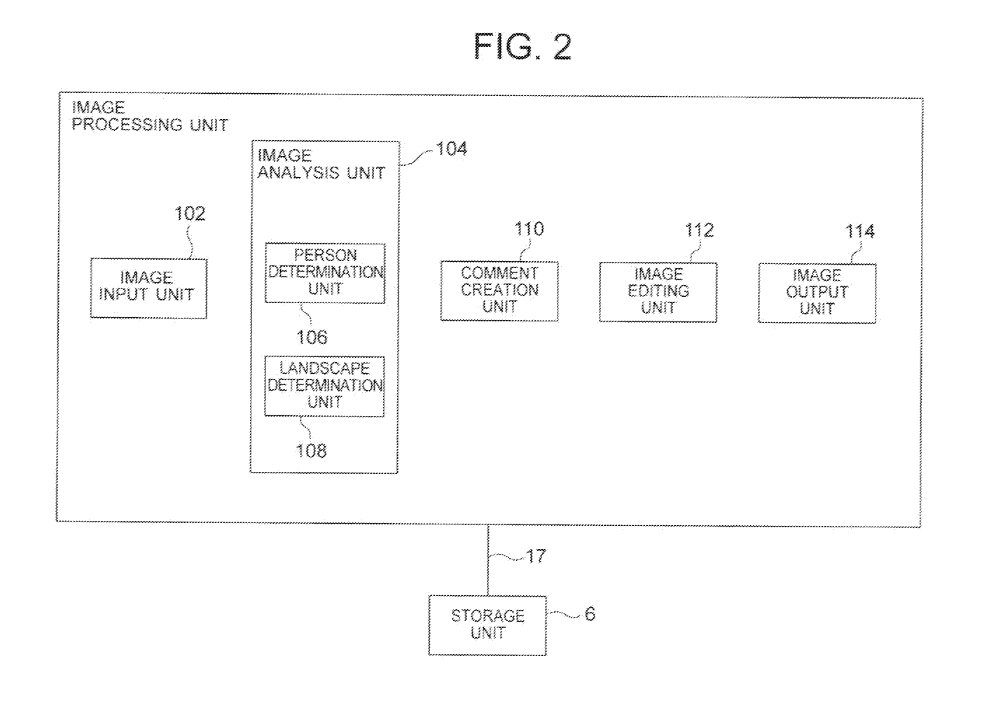

The image processing unit 13 is a digital circuit for performing image processing such as interpolation processing, edge enhancement processing, or white balance correction and generating image files of Exif format, etc. to which photographing conditions, imaging information or the like are added as header information. Further, as shown in FIG. 2, the image processing unit 13 includes an image input unit 102, an image analysis unit 104, a comment creation unit 110, an image editing unit 112 and an image output unit 114, and performs an image processing described below with respect to an input image.

The image input unit 102 inputs an image such as a still image or a through-image. For example, the image input unit 102 inputs the images output from the A/D converter 3 shown in FIG. 1, the images stored in the buffer memory 4, or the images stored in the card memory 8. As another example, the image input unit 102 may input images through a network (not shown in Fig.). The image input unit 102 outputs the input images to the image analysis unit 104 and the image editing unit 112.

The image analysis unit 104 performs an analysis of the input images input from the image input unit 102. For example, the image analysis unit 104 performs a calculation of the image feature quantity (for example, color distribution, brightness distribution, and contrast), a face recognition or the like with respect to the input image and outputs the result of the image analysis to the comment creation unit 110. In the present embodiment the face recognition is performed using any known technique. Further, the image analysis unit 104 obtains the imaging date and time, the imaging location and temperature, etc. based on the header information imparted to the input image. The image analysis unit 104 outputs the result of the image analysis to the comment creation unit 110.

The image analysis unit 104 includes a person determination unit 106 and a landscape determination unit 108, and performs a scene determination of the input image based on the image analysis result. The person determination unit 100 outputs the scene determination result to the image editing unit 112 after determining whether the input image is a person image or not on the basis of the image analysis result. The landscape determination unit 108 outputs the scene determination result to the image editing unit 112 after determining whether the input image is a landscape image or not on the basis of the image analysis result.

The comment creation unit 110 creates a comment for the input image based on the image analysis result inputted from the image analysis unit 104. The comment creation unit 110 creates a comment on the basis of a correspondence relation between the image analysis result from the image analysis unit 104 and text data stored in the storage unit 6. As another example, it is also possible that the comment creation unit 110 displays a plurality of comment candidates on the display unit 16 and the user sets a comment from among the plurality of comment candidates by operating the touch panel button 17. The comment creation unit 110 outputs the comment to the image editing unit 112 and the image output unit 114.

The image editing unit 112 creates a display image from an input image input from the image input unit 102 based on the scene determination result from the person determination unit 106 or the landscape determination unit 108. Note that, the display image to be created may be a single image or a plurality of images. The image editing unit 112 may create a display image by using the comment from the comment creation unit 110 and/or the image analysis result from the image analysis unit 104 together with the scene determination result.

The image output unit 114 outputs an output image composed of a combination of the comment from the comment creation unit 110 and the display image from the image editing unit 112 to the display unit 16 shown in FIG. 1. That is, the image output unit 114 inputs the comment and the display image, and set a text composite area in the display image to add the comment to the text composite area. An arbitrary method is employed to set the text composite area with respect to the display image. For example, it is possible to set the text composite area in a non-important area other than an important area wherein relatively important object is included in the display image. Specifically, an area wherein a person's face is included is classified into the important area and the non-important area not including the important area is set to be the text composite area to superimpose the comments on the text composite area. Also, it is possible that the user sets the text composite area by operating the touch panel button 17.

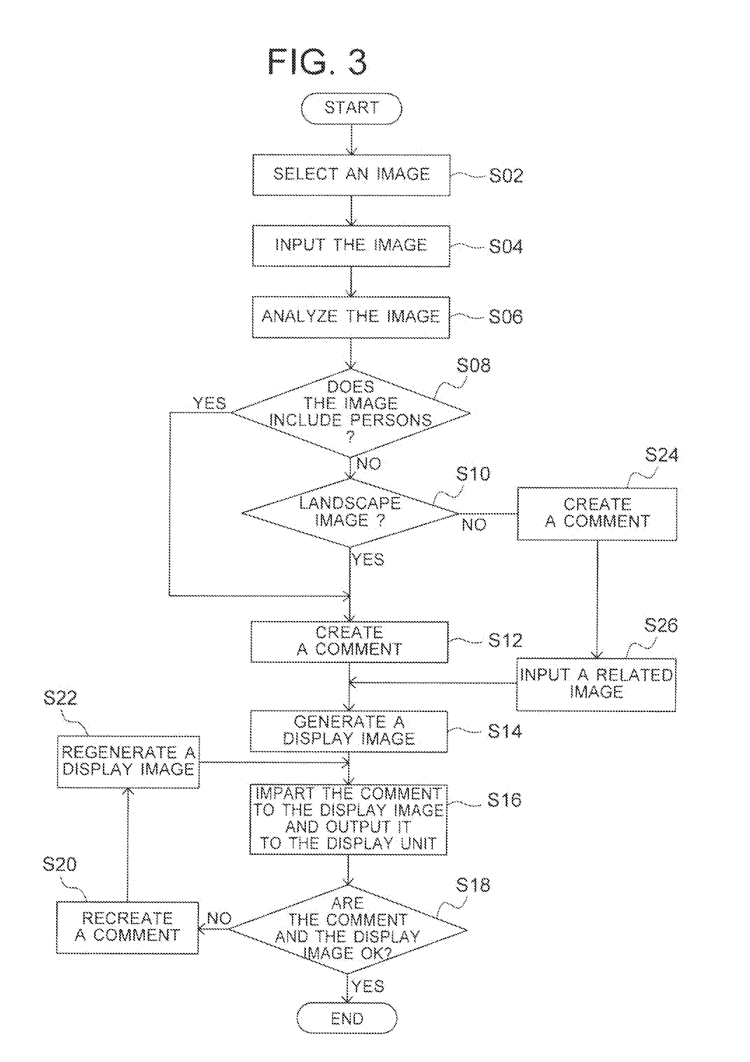

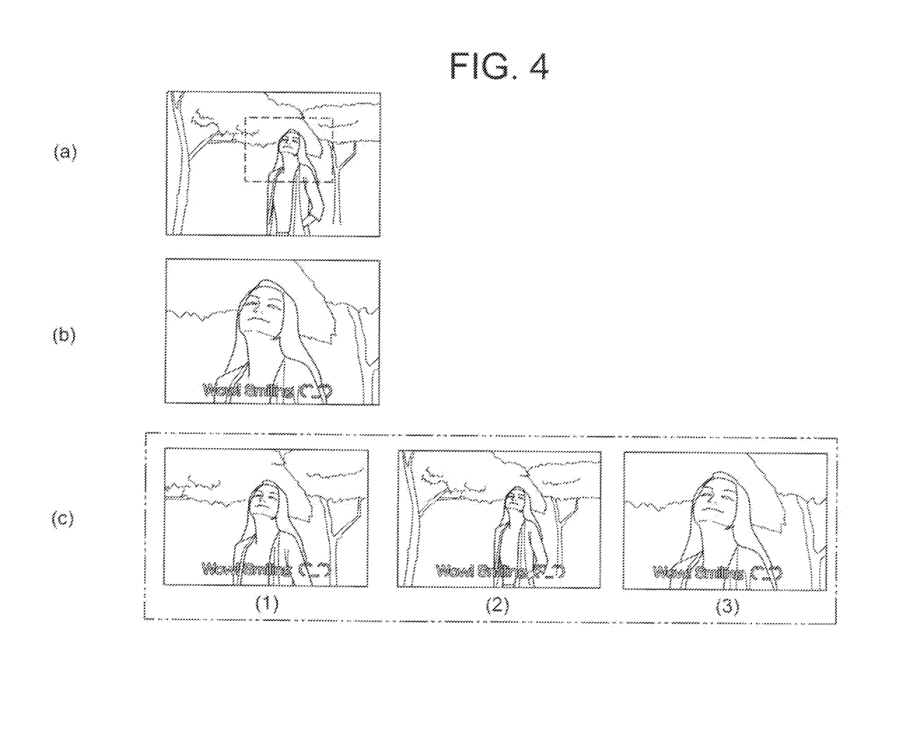

The following describes an example of the image processing in this embodiment with reference to FIGS. 3 and 4. To begin with, the user operates the touch panel button 17 shown in FIG. 1 to switch to an image processing mode for performing the image processing in this embodiment.

In step S02 shown in FIG. 3, the user operates the touch panel button 17 shown in FIG. 1 to select and determine an image to be processed from the candidates of the image displayed on the display unit 13. In this embodiment, the image shown in FIG. 4 (a) is selected.

In step S04, the image selected in step S02 is transferred from the card memory 8 to the image input unit 102 via the bus 18 shown in FIG. 2. The image input unit 102 outputs the input image to the image analysis unit 104 and the image editing unit 112.

In step S06, the image analysis unit 104 shown in FIG. 2 performs image analysis of the input image shown in FIG. 4 (a). For example, the image analysis unit 104 performs face recognition, etc. to determine the number of people being captured on the input image and perform smiling face determination based on the sex and the degree of curving of the mouth corners, etc. of each person with respect to the input image shown in FIG. 4 (a). In this embodiment, the sex determination and the smiling-face determination of each person are performed using any known method. For example, the image analysis unit 104 outputs the image analysis result indicating “1 person, female, smiling face” to the comment creation unit 110 shown in FIG. 2 with respect to the input image shown in FIG. 4 (a).

In step S08, the person determination unit 106 of the image analysis unit 104 shown in FIG. 2 determines that the input image shown in FIG. 4 (a) is a person image on the oasis of the image analysis result of “1 person, female, smiling face” in step S06. The person determination unit 106 outputs the scene determination result indicating “person image” to the image editing unit 112. In this embodiment where the input image is a person image, the process proceeds to step S12 (Yes side).

In step S12, the comment creation unit 110 shown in FIG. 2 creates the comment “Wow! Smiling (̂ _ ̂)” based on the image analysis result received from the image analysis unit 104 indicating “1 person, female, smiling face”. The comment creation unit 110 outputs the comment to the image output unit 114.

In step S14, the image editing unit 112 shown in FIG. 2 generates the display image shown in FIG. 4 (b) (no comment has been imparted at this stage) on the basis of the scene determination result indicating “person image” received from the person determination unit 106. That is, the image editing unit 112 edits the input image into a close-up image of the area centering on the face of the person surrounded by a broken line in FIG. 4 (a) based on the input of “person image”. The image editing unit 113 outputs the display image that is the close-up image of the face of the person to the image output unit 114.

In step S16, the image output unit 114 combines the comment created in step S12 and the display image generated in step S14, and outputs the output image shown in FIG. 4 (b) to the display unit 16 shown in FIG. 1.

In step S18, the user confirms the output image displayed on the display unit 16 shown in FIG. 1. When the user is satisfied with the output image shown in FIG. 4 (b), the output image is stored in the storage unit 6 and the image processing is terminated by operating the touch panel button 17. When saving the output image, it is stored in the storage unit 6 as an image file of Exif format, etc. to which imaging information and parameters in the image processing are added as header information.

On the other hand, when the user is not satisfied with the output image shown in FIG. 4 (b), the process proceeds to step S20 (No side) by operating the touch panel button 17. In this case, the comment creation unit 110 displays the plurality of comment candidates on the display unit 16 based on the image analysis result in step S06. The user selects a comment suitable for the image from the comment candidates displayed on the display unit 16 by operating the touch panel button 17. The comment creation unit 112 outputs a comment selected by the user to the image output unit 114.

Next, in step S20, the image editing unit 112 shown in FIG. 2 generates the display image on the basis of the scene determination result from the person determination unit 106 and the comment selected by the user in step S20. The image editing unit 112 may display the plurality of display image candidates on the display unit 16 based on the scene determination result and the comment selected by the user. The user determines the display image by operating the touch panel button 17 and selecting a display image from among the plurality of candidates. The image editing unit 112 outputs the display image to the image output unit 114 and the process proceeds to step S16.

Note that, in the above embodiment, although the number of output image is a single as shown in FIG. 4 (b), it may be plural as shown in FIG. 4 (c).

In this case, in step S14, the image editing unit 112 shown in FIG. 2 generates the plurality of display images shown in FIG. 4 (c) (no comment has been imparted at this stage) based on the scene determination result from the person determination unit 106. That is, the image editing unit 112 generates an initial image (1) (corresponding to FIG. 4 (a)), an intermediate image (2) (corresponding to an image obtained by zooming-up the initial image (1) with a person in it as a center) and a final image (3) (corresponding to an image obtained by further zooming-up the intermediate image (2) with the person as a center) shown in FIG. 4 (c). The image editing unit 112 outputs the display image composed of the plurality of images to the image output unit 114.

In step S16, the image output unit 114 combines the comment created in step S12 and the display image generated in step S14, and outputs the output image shown in FIG. 4 (c) to the display unit 16 shown in FIG. 1. That is, the image output unit 114 outputs a slideshow that sequentially displays the series of images shown in (1) to (3) of FIG. 4 (c) along with the comment.

Note that, in the present embodiments, although the comment is imparted to all of the images shown in (1) to (3) of FIG. 4 (c), it is also possible that the comment is imparted only to the final image (3) without being imparted to the initial image (1) and the intermediate image (2).

Further, in the present embodiment, although the three images, that is, the initial image (1), the intermediate image (2) and the final image (3) are output, it is also possible that the two images, that is, the initial image (1) and the final image (3) are output. Also, it is possible that an intermediate image is composed of two or more images to zoom-up more smoothly.

Thus, in the present embodiment, the comment describing facial expression and the display image where the facial expression is closed up are combined and output as an output image. Therefore, in the present embodiment, it is possible to obtain an output image where the comment and the display image are matched.

### Second Embodiment

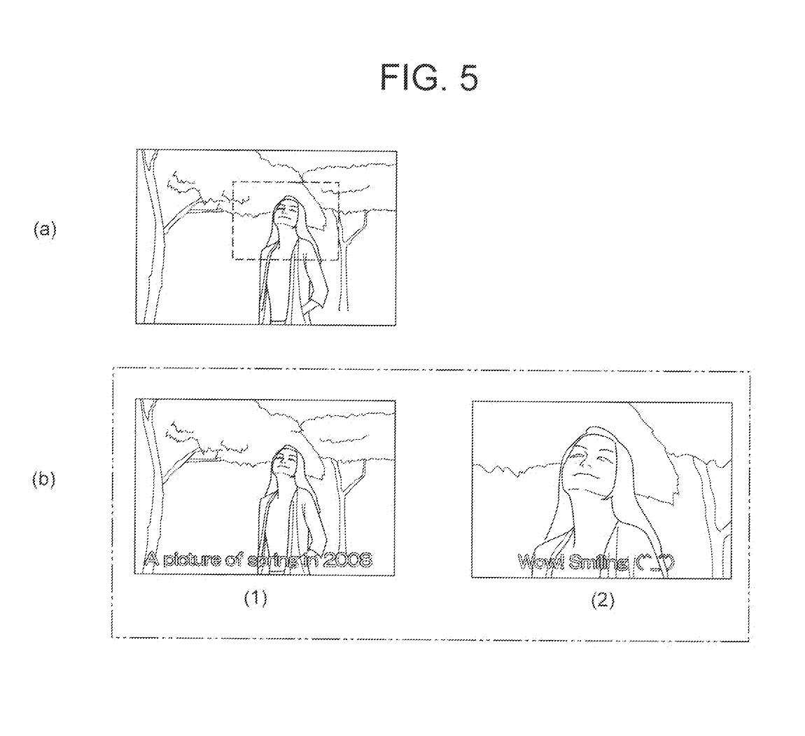

As shown in FIG. 5 (b), the second embodiment is similar with the first embodiment, except that the comment to be imparted to the output image differs from that of the first embodiment. In the following, specification of common portion therewith will be omitted and only different portion will be specified.

In step S06 shown in FIG. 3, the image analysis unit 104 shown in FIG. 2 performs image analysis of the input image shown in FIG. 5 (a). The image analysis unit 104 outputs the image analysis result indicating “1 person, female, smiling face” to the comment creation unit 110 shown in FIG. 2 with respect to the input image shown in FIG. 4 (a), as in the first embodiment. Further, the image analysis unit 104 obtains the information of “April 14, 2008” from the header information of the input image and outputs it to the comment creation unit 110.

In step S08, the person determination unit 106 of the image analysis unit 104 shown in FIG. 2 determines that the input image shown in FIG. 4 (a) is a person image from the image analysis result of “1 person, female, smiling face” in step S06. The person determination unit 106 outputs a scene determination result of “person image” to the image editing unit 112. In this embodiment where the input image is a person image, the process proceeds to step S12 (Yes side).

In step S12, the comment creation unit 110 shown in FIG. 2 creates the comments “A picture of spring in 2008” and “Wow! Smiling (̂ _ ̂)” based on the image analysis result from the image analysis unit 104 indicating “April 14, 2008” and “1 person, female, smiling face”. The comment creation unit 110 outputs the comments to the image output unit 114.

In step S14, the image editing unit 112 shown in FIG. 2 generates the plurality of display images shown in FIG. 5 (b) (no comment has been imparted at this stage) on the basis of the scene determination result indicating “person image” from the person determination unit 106. That is, the image editing unit 112 generates an initial image (1) (corresponding to FIG. 5 (a)) and a zoom-up image (2) (corresponding to an image obtained by zooming-up the initial image (1) with a person in it as a center) shown in FIG. 5 (b). The image editing unit 112 outputs the display image composed of the plurality of images to the image output unit 114.

In step S16, the image output unit 114 combines the comment created in step S12 and the display image generated in step S14, and outputs the output image shown in FIG. 5 (b) to the display unit 16 shown in FIG. 1. In the present embodiment, the comment matched with each of the plurality of images is imparted to them, specifically, the comment to be imparted to the images is changed according to the level of zoom-up of the image. That is, the image output unit 114 outputs a slideshow that sequentially displays the output image as a combination of the initial image and the comment of “A picture of spring in 2008” shown in FIG. 5 (b) (1) and the output image as a combination of the zoom-up image and the comment of “Wow! Smiling (̂ _ ̂)” shown in FIG. 5 (b) (2).

Thus, in the present embodiment, the image obtained by imparting a comment concerning the date and time to the initial image before zoom-up and the image obtained by imparting a comment matching the zoomed-up image after zoom-up to the zoomed-up image are used to output the slideshow. Therefore, in the present embodiment, it is possible to remind the user of the memory in photographing more clearly by the comment matching the zoomed-up image that is imparted to the zoomed-up image while remembering the memory in photographing by associating with the comment concerning the data and time that is imparted to the initial image.

### Third Embodiment

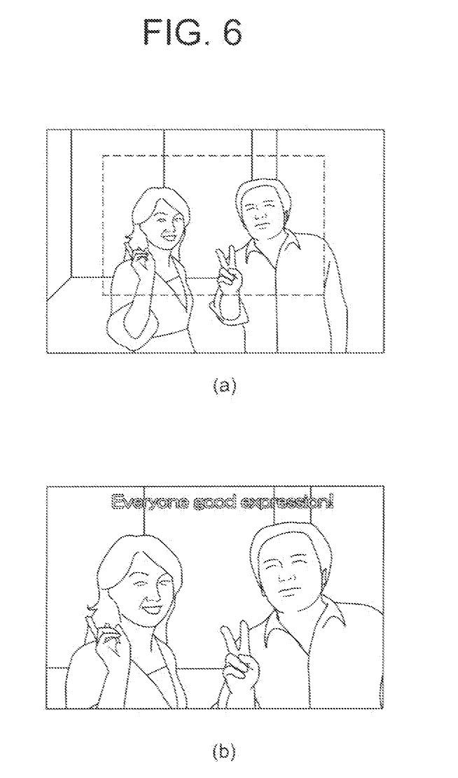

As shown in FIG. 6 (a), the third embodiment is similar with the first embodiment, except that the plurality of persons are included in the input image. In the following, specification of common portion therewith will be omitted and only different portion will be specified.

In step S06 shown in FIG. 3, the image analysis unit 104 shown in FIG. 2 performs image analysis of the input image shown in FIG. 6 (a). In the present embodiment, for example, the image analysis unit 104 outputs the image analysis result indicating “2 persons, 1 male and 1 female, smiling face” to the comment creation unit 110 shown in FIG. 2 with respect to the input image shown in FIG. 6 (a).

In step S08, the person determination unit 106 of the image analysis unit 104 shown in FIG. 2 determines that the input image shown in FIG. 6 (a) is a person image from the image analysis result of “2 persons, 1 male and 1 female, smiling face” in step S06. The person determination unit 106 outputs a scene determination result of “person image” to the image editing unit 112. In this embodiment where the input image is a person image, the process proceeds to step S12 (Yes side).

In step S12, the comment creation unit 110 shown in FIG. 2 creates the comment “Everyone good expression!” based on the image analysis result from the image analysis unit 104 indicating “2 persons, 1 male and 1 female, smiling face”. The comment creation unit 110 outputs the comment to the image editing unit 112 and the image output unit 114.

In step S14, the image editing unit 110 shown in FIG. 2 generates the display images shown in FIG. 6 (b) (no comment has been imparted at this stage) on the basis of the scene determination result indicating “person image” from the person determination unit 106 and the comment “Everyone good expression!” from the comment creation unit 110. That is, the image editing unit 112 edits the image into a close-up image of the area centering on the faces of the two persons surrounded by a broken line in FIG. 6 (a) based on the input of “person image” and “Everyone good expression!”. The image editing unit 112 outputs the display image to the image output unit 114.

In step S16, the image output unit 114 combines the comment created in step S12 and the display image generated in step S14, and outputs the output image shown in FIG. 6 (b) to the display unit 15 shown in FIG. 1.

### Fourth Embodiment

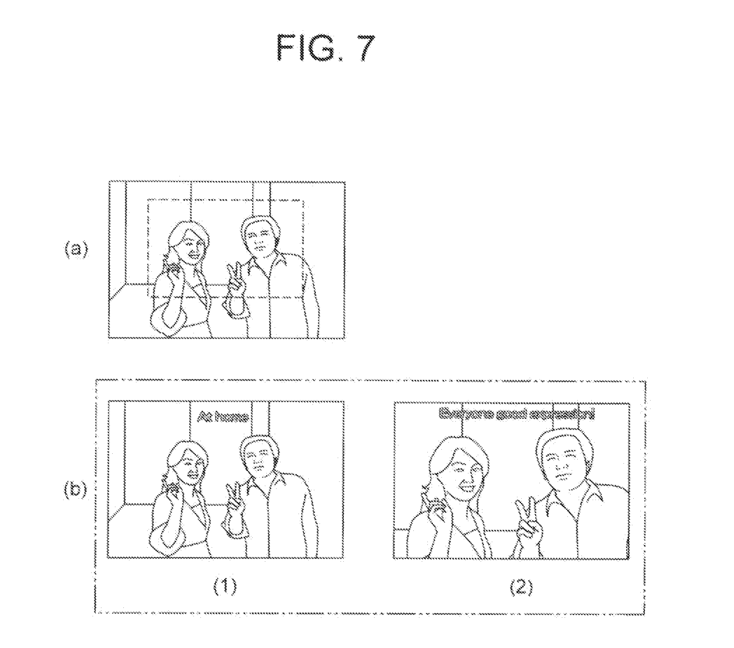

As shown in FIG. 7 (b), the fourth embodiment is similar with the third embodiment, except that the output images exist plurally and the comment to be imparted to the output image differs from that of the third embodiment. In the following, specification of common portion therewith will be omitted and only different portion will be specified.

In step S06 shown in FIG. 3, the image analysis unit 104 shown in FIG. 2 performs image analysis of the input image shown in FIG. 7 (a). The image analysis unit 104 outputs the image analysis result indicating “2 persons, 1 male and 1 female, smiling face” to the comment creation unit 110 shown in FIG. 2 with respect to the input image shown in FIG. 7 (a), as in the third embodiment. Further, the image analysis unit 104 obtains the information of “xx City xx Town xx (position information)” from the header information of the input image and outputs it to the comment creation unit 110.

In step S08, the person determination unit 106 of the image analysis unit 104 shown in FIG. 2 determines that the input image shown in FIG. 7 (a) is a person image from the image analysis result of “2 persons, 1 male and 1 female, smiling face” in step S06. The person determination unit 106 outputs a scene determination result of “person image” to the image editing unit 112. In this embodiment where the input image is a person image, the process proceeds to step S12 (Yes side).

In step S12, the comment creation unit 110 shown in FIG. 2 creates the comments of “At home” and “Everyone good expression!” based on the image analysis result from the image analysis unit 104 indicating “xx City xx Town, xx (position information)” and “2 persons, 1 male and 1 female, smiling face”. The comment creation unit 110 outputs the comment to the image output unit 114.

In step S14, the image editing unit 112 shown in FIG. 2 generates the plurality of display images shown in FIG. 7 (b) (no comment has been imparted at this stage) on the basis of the scene determination result indicating “person image” from the person determination unit 106. That is, the image editing unit 112 generates an initial image (1) (corresponding to FIG. 7 (a)) and a zoom-up image (2) (corresponding to the close-up image of the area centering on the faces of the two persons surrounded by a broken line in FIG. 7 (a)) shown in FIG. 7 (b). The image editing unit 112 outputs the display image composed of the plurality of images to the image output unit 114.

In step S16, the image output unit 114 combines the comment created in step S12 and the display image generated in step S14, and outputs the output image shown in FIG. 7 (b) to the display unit 16 shown in FIG. 1. In the present embodiment, the comment matched with each of the plurality of images is imparted to them, specifically, the comment to be imparted to the images is changed according to the level of zoom-up of the image. That is, the image output unit 114 outputs a slide show that sequentially displays the output image as a combination of the initial image and the comment of “At home” shown in FIG. 7 (b) (1) and the output image as a combination of the zoom-up image and the comment of “Everyone good expression!” and shown in FIG. 7 (b) (2).

Thus, in the present embodiment, the image obtained by imparting a comment concerning the position information to the initial image before zoom-up and the image obtained by imparting a comment matching the zoomed-up image after zoom-up to the zoomed-up image are need to output the slideshow. Therefore, in the present embodiment, it is possible to remind the user of the memory in photographing more clearly by the comment matching the zoomed-up image that is imparted to the zoomed-up image while remembering the memory in photographing by associating with the comment concerning the position information that is imparted to the initial image.

### Fifth Embodiment

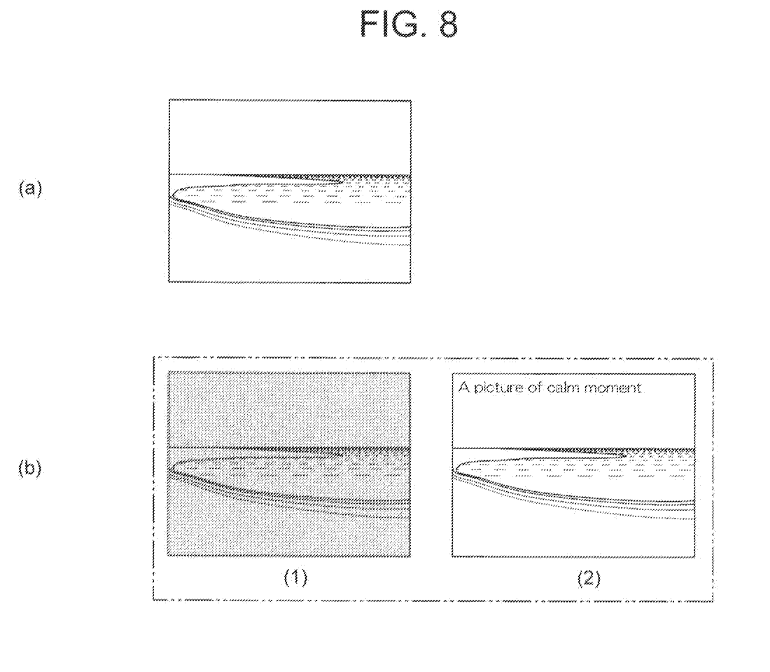

As shown in FIG. 8 (a), the fifth embodiment is similar with the first embodiment, except that the input image is a landscape image including shore. In the following, specification of common portion therewith will be omitted and only different portion will be specified.

In step S06 shown in FIG. 3, the image analysis unit 104 shown in FIG. 2 performs image analysis of the input image shown in FIG. 8 (a). The image analysis unit 104 outputs an image analysis result such as “sunny, sea” to the image editing unit 112 shown in FIG. 2 with respect to the image shown in FIG. 8 (a) from that the rate and brightness of the color distribution of blue color are large and the focal distance is long.

In step S08, the person determination unit 106 shown in FIG. 2 determines that the image shown in FIG. 8 (a) is not a person image from the image analysis result of “sunny, sea” by the image analysis unit 104.

In step S10, the landscape determination unit 108 shown in FIG. 2 determines that the input image shown in FIG. 8 (a) is a landscape image from the image analysis result of “sunny, sea” and outputs a scene determination result of “landscape image” to the image editing unit 112.

In step S12, the comment creation unit 110 shown in FIG. 2 creates the comment “A picture of calm moment” based on the image analysis result from the image analysis unit 104 indicating “sunny, sea”. The comment creation unit 110 outputs the comments to the image editing unit 112 and the image output unit 114.

In step S14, the image editing unit 112 generates the display image shown in FIG. 8 (b) on the basis of the scene determination result indicating “landscape image” from the landscape determination unit 108 and the comment of “A picture of calm moment” from the comment creation unit 110. That is, in the present embodiment, the display image whose luminance is gradually changed is generated. Specifically, the display image (no comment has been imparted at this stage) that is gradually lightened from the initial image (1) shown in FIG. 8 (b) displayed slightly darker than the input image shown in FIG. 8 (a) to the final image (2) (corresponding to FIG. 8 (a)) is generated.

In step S16, the image output unit 114 combines the comment created in step S12 and the display image generated in step S14, and outputs the output image shown in FIG. 8 (b) to the display unit 16 shown in FIG. 1. In this case, the image output unit 114 does not impart the comment at the stage where the luminance is gradually changed from the initial image (1) shown in FIG. 8 (b) to the final image (2) and impart the comment when reaching the final image (2). Note that, it is also possible to impart the comment at the stage where the luminance is gradually changed from the initial image (1) to the final image (2).

As described above, in the present embodiment, it is possible to further improve the matching between the image finally displayed and the text by gradually changing the luminance to highlight the color and the atmosphere of the whole image that is finally displayed.

### Sixth Embodiment

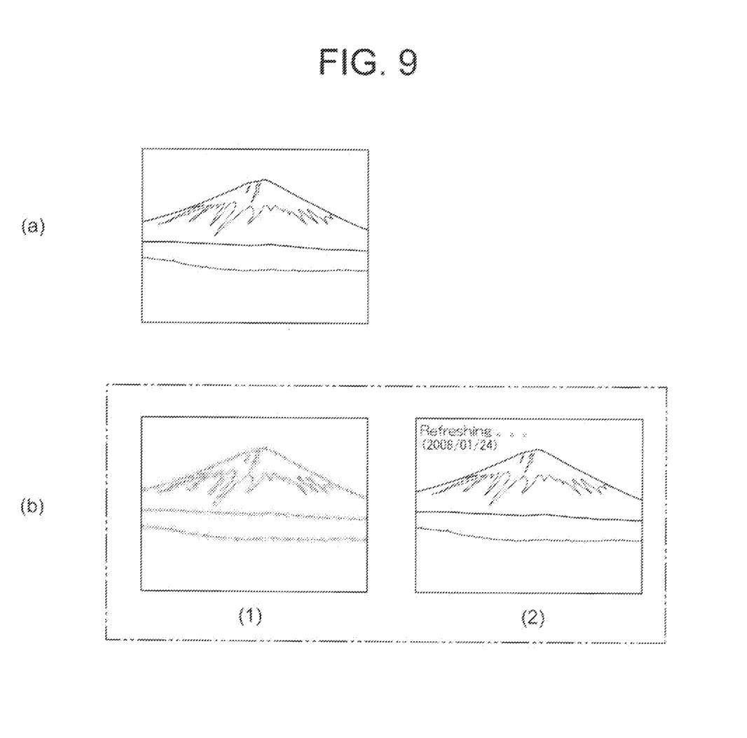

As shown in FIG. 9 (a), the sixth embodiment is similar with the fifth embodiment, except that the input image is a landscape image including mountain. In the following, specification of common portion therewith will be omitted and only different portion will be specified.

In step S06 shown in FIG. 3, the image analysis unit 104 shown in FIG. 2 performs image analysis of the input image shown in FIG. 9 (a). The image analysis unit 104 performs the analysis such as “sunny, mountain” with respect to the image shown in FIG. 9 (a) from that the rate and brightness of the color distribution of blue color and green color are large and the focal distance is long. Further, the image analysis unit 104 obtains the information that the image has been acquired on “January 24, 2008” from the header information of the input image. The image analysis unit 104 outputs the image analysis result to the image editing unit 112 shown in FIG. 2. Note that, it is also possible that the image analysis unit 104 obtains the photographing place from the header information of the input image and analyses the name of the mountain based on the photographing place and the image analysis result of “sunny, mountain”.

In step S08, the person determination unit 106 shown in FIG. 2 determines that the image shown in FIG. 9 (a) is not a person image from the image analysis result of “sunny, mountain” by the image analysis unit 104.

In step S10, the landscape determination unit 108 shown in FIG. 2 determines that the input image shown in FIG. 9 (a) is a landscape image from the image analysis result of “sunny, mountain” and outputs a scene determination result of “landscape image” to the image editing unit 112.

In step S12, the comment creation unit 110 shown in FIG. 2 creates the comments “Refreshing . . . ” and “2008/1/24” based on the image analysis result from the image analysis unit 104 indicating “sunny, mountain” and “January 24, 2008” . The comment creation unit 110 outputs the comments to the image editing unit 112 and the image output unit 114.

In step S14, the image editing unit 112 generates the display image shown in FIG. 9 (b) on the basis of the scene determination result indicating “landscape image” from the landscape determination unit 108 and the comment of “sunny, mountain” from the comment creation unit 110. That is, in the present embodiment, the display image whose focus is gradually changed is generated. Specifically, the display image (no comment has been imparted at this stage) that is gradually focused from the initial image (1) shown in FIG. 9 (b) which is the blurred image of the input image shown in FIG. 9 (a) to the final image (2) (corresponding to FIG. 9 (a)) is generated.

In step S16, the image output unit 114 combines the comment created in step S12 and the display image generated in step S14, and outputs the output image which is displayed so as to be gradually focused to the display unit 16 shown in FIG. 1 as shown in FIG. 9 (b).

As described above, in the present embodiment, it is possible to further improve the matching between the image finally displayed and the text by gradually adjusting the focus to highlight the color and the atmosphere of the whole image that is finally displayed.

### Seventh Embodiment

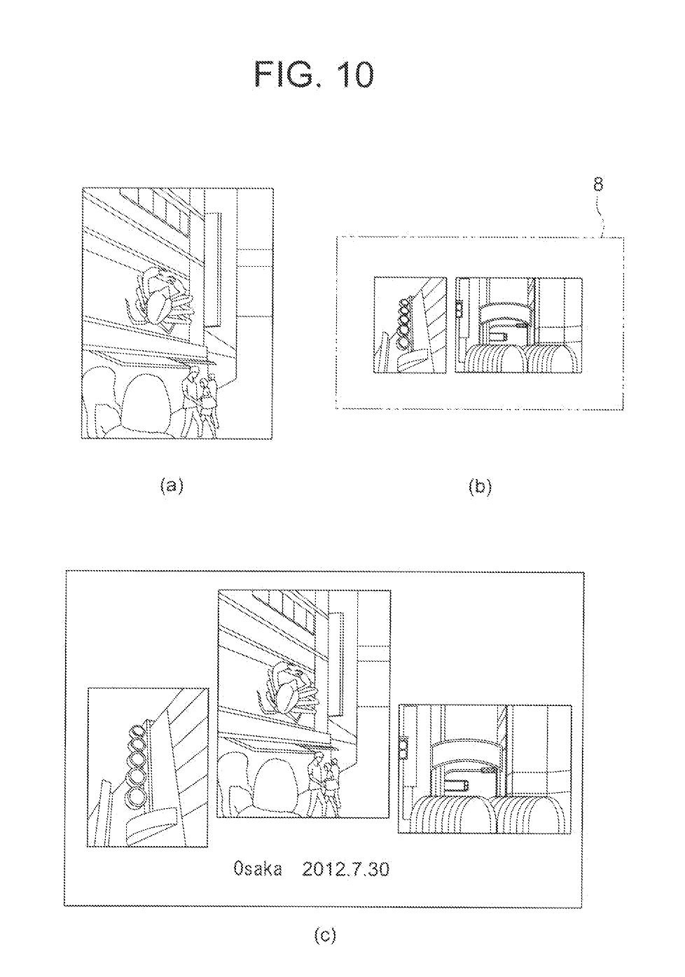

As shown in FIG. 10 (a), the seventh embodiment is similar with the first embodiment, except that the input image is an image including various objects such as persons, buildings, signs, roads and a sky. In the following, specification of common portion therewith will be omitted and only different portion will be specified.

In step S06 shown in FIG. 3, the image analysis unit 104 shown in FIG. 2 performs image analysis of the input image shown in FIG. 10 (a). The image analysis unit 104 performs the analysis such as “other images” with respect to the image shown in FIG. 10 (a) from that various colors are included in it. Further, the image analysis unit 104 obtains the information of “July 30, 2012, Osaka” from the header information of the input image. The image analysis unit 104 outputs the image analysis result to the image editing unit 112 shown in FIG. 2.

In step S08, the person determination unit 106 shown in FIG. 2 determines that the image shown in FIG. 10 (a) is not a person image from the image analysis result of “other images” by the image analysis unit 104.

In step S10, the landscape determination unit 108 shown in FIG. 2 determines that the input image shown in FIG. 10 (a) is not a landscape image from the image analysis result of “other images”. The process proceeds to step S24 (No side).

In step S24, the comment creation unit 110 shown in FIG. 2 creates the comment “Osaka 2012.7.30” based on the image analysis result from the image analysis unit 104 indicating “other images” and “July 30, 2012, Osaka”. The comment creation unit 110 outputs the comment to the image editing unit 112 and the image output unit 114.

In step S26, the image input unit 102 inputs the related image in the card memory 8 shown in FIG. 10 (b) on the basis of the scene determination result indicating “other images” from the landscape determination unit 108 and the comment of “Osaka 2012.7.30” from the comment creation unit 110. That is, the image input unit 102 inputs the related image shown in FIG. 10 (b) that is captured on July 30, 2012 in Osaka on the basic of the information of “Osaka 2012.7.30”. Note that, it is also possible that the image input unit 102 inputs the related image related to information such as time and date, place and temperature based on these information.

In step S14, the image editing unit 112 generates the display image shown in FIG. 10 (c) on the basis of the scene determination result indicating “other images” from the landscape determination unit 108 and the comment of “Osaka 2012.7.30” from the comment creation unit 110. That is, in the present embodiment, the image editing unit 112 combines the input image shown in FIG. 10 (a) and the two related images shown in FIG. 10 (b). In the present embodiment, the input image shown in FIG. 10 (a) is arranged in the center so that the input image shown in FIG. 10 (a) stands out. The image editing unit 112 outputs the display image to the image output unit 114.

In step S16, the image output unit 114 combines the comment created in step S12 and the display image generated in step S14, and outputs the output image shown in FIG. 10 (c) to the display unit 16 shown in FIG. 1.

Thus, in the present embodiment, the comment describing the date, time and place and the display image where the images whose date, time and place are close to each other are grouped are combined to output the output image. Therefore, in the present embodiment, the comment and the display image are matched, and it is possible to remind the user of the memory in photographing by associating with the comment and the grouped display image.

### Eighth Embodiment

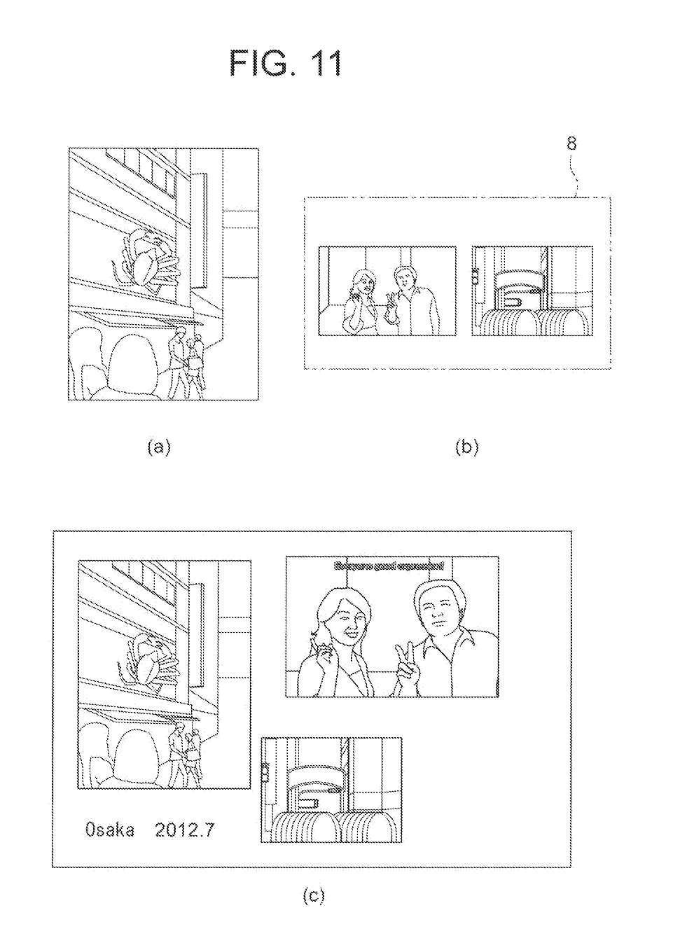

As shown in FIG. 11 (b), the eighth embodiment is similar with the seventh embodiment, except that the related image includes a person image. In the following, specification of common portion therewith will be omitted and only different portion will be specified.

In step S26 shown in FIG. 3, the image input unit 102 inputs the related image in the card memory 8 shown in FIG. 11 (b) on the basis of the scene determination result indicating “other images” from the landscape determination unit 108 and the comment of “Osaka 2012.7.30” from the comment creation unit 110. In the present embodiment, as shown in the left side of FIG. 11 (b), the related image includes a person image. When the related image includes a person image, similar to the above mentioned embodiment, the person image is zoomed up and the comment associated with the facial expression of the person image is imparted to the zoomed-up image, as shown in the upper right of FIG. 11 (c).

In step S14, the image editing unit 112 generates the display image shown in FIG. 11 (c) on the basis of the scene determination result indicating “other images” from the landscape determination unit 108 and the comment of “Osaka 2012.7.30” from the comment creation unit 110. That is, in the present embodiment, the image editing unit 112 combines the input image shown in FIG. 11 (a) and the two related images shown in FIG. 11 (b). In the present embodiment, the input image shown in FIG. 11 (a) and the person image shown in the left side of FIG. 11 (b) are displayed larger than the other images so that the input image and the person image stand out. The image editing unit 112 outputs the display image to the image output unit 114.

In step S16, the image output unit 114 combines the comment created in step S12 and the display image generated in step S14, and outputs the output image shown in FIG. 11 (c) to the display unit 16 shown in FIG. 1.

Note that, the present invention is not limited to the above embodiments.

In the above embodiments, although the image analysis unit 104 shown in FIG. 2 includes the person determination unit 106 and the landscape determination unit 108, the image analysis unit 104 may further include other determination units such as animal determination unit or friend determination unit. For example, in the case of scene determination result of animal image, the image processing for zooming up the animals may be performed, and in the case of scene determination result of friend image, the display image where the friend images are grouped may be generated.

In the above embodiments, although the image processing is performed in the editing mode of the camera 50, it is also possible that the image processing is performed and the output image is displayed on the display unit 16 at the time of photographing by the camera 50. For example, the output image may be generated and displayed on the display unit 16 when the release button is half-depressed by the user.

In the above embodiments, although the output image is recorded in the storage unit 6, for example, it is also possible that the photographed image is recorded as an image file of Exif format, etc. together with parameters of the image processing instead of recording the output image itself in the storage unit.

In addition, it is also applicable that a computer provided with a program for performing each of the steps in the image processing device according to the present invention functions as the image processing device.

The present invention may be embodied in other various forms without departing from the spirit or essential characteristics thereof. Therefore, the above-described embodiments are merely illustrations in all respects and should not be construed as limiting the present invention. Moreover, variations and modifications belonging to the equivalent scope of the appended claims are all within the scope of the present invention.

### DESCRIPTION OF THE REFERENCE SIGNS

6 Storage unit

13 Image processing unit

16 Display unit

17 Touch panel button

50 Camera

102 Image input unit

104 Image analysis unit

106 Person determination unit

108 Landscape determination unit

110 Comment creation unit

112 Image editing unit

114 Image output unit

1. An image processing device comprising:
an image input unit which inputs an image;
a comment creation unit which carries out an image analysis of the image and creates a comment;
an image editing unit which edits the image on the basis of the results of the analysis; and
an image output unit which outputs an output image including the comment and the edited image.

2. The image processing device according to claim 1, wherein
said edited image comprises a plurality of images, and
said image output unit outputs said edited image to switch the plurality of images.

3. The image processing device according to claim 1, wherein
said comment comprises a plurality of comments, and
said image output unit outputs said comment to switch the plurality of comments.

4. The image processing device according to claim 2, wherein
said image output unit outputs said edited image to switch the plurality of images from a first timing to a second timing, and outputs a combination of the comment and the image switched at the second timing when the second timing comes.

5. The image processing device according to claim 1, further comprising:
a person determination unit which carries out a scene determination to determine whether the image is a person image or not, wherein
said image editing unit generates a zoom-up image magnified with a person as a center in the person image from said image, when the image is the person image.

6. The image processing device according to claim 1, further comprising:
a landscape determination unit which carries out a scene determination to determine whether the image is a landscape image or not, wherein
said image editing unit generates a comparison image having a varied image quality from the image when the image is a landscape image.

7. The image processing device according to claim 1, wherein
said comment creation unit carries out the image analysis on the basis of the image and an imaging information of the image,
said image input unit further inputs a related image related to the image on the basis of the imaging information, when the image is neither a person image nor a landscape image,
said image editing unit combines and edits the comment the image and the related image to generate a combined and edited image.

8. An imaging device comprising the image processing device according to claim 1.

9. A program for making a computer carry out the following steps:
an image input step for inputting an image,
a comment creation step for carrying out an image analysis of the image and creates a comment,
an image editing step for editing the image on the basis of the results of the analysis, and
an image output step for outputting an output image including the comment and the edited image.
